(19) United States
(12) Patent Application Publication
(10) Pub. No.: US 2005/0048257 A1
(43) Pub. Date: Mar. 3, 2005

(54) Saddle backing

(76) Inventors: Peter Mattes, Mahlstetten (DE); Peter Menet, Stein (CH)

Correspondence Address: Patrick J O Shea;Gauthier & Connors, Suite 3300, 225 Franklin Street, Boston, MA, 02110, US

(21) Appl. No.: 10/486,523

(22) PCT Filed: Aug. 8, 2002
(86) PCT No.: PCT/EP02/08871

(30) Foreign Application Priority Data
Aug. 10, 2001 (DE) 101 38 317.7

(51) Int. Cl. B32B 3/10

(52) U.S. Cl. 428/131; 428/156

(57) ABSTRACT

The aim of the invention is to configure a saddle backing (1) for a riding animal that is as anatomically compatible as possible. To achieve this, two lateral sections (3), e.g. consisting of lambskin (7) are interconnected by means of a web element (4), in which a recess (6) in the shape of a longitudinal groove is fashioned, said recess extending along the vertebral column (5) of the riding animal, in such a way that no pressure is exerted on said vertebral column (5). The weight of a rider is thus distributed over a large surface area on the lateral sections (3) lying on the flanks of the riding animal.

The invention relates to a saddle pad for laying on the back of a riding animal.

Because riding animals, in particular horses, are especially sensitive in the back region where the saddle rests, saddles, saddlecloths, and the like should be optimally adapted to the anatomy of the riding animal. Such saddle pads must not press on the spine of the riding animal.

It has heretofore been known to fasten the saddle pad in the so-called gullet channel on the underside of the saddle using a special hook-and-loop tape. For this purpose a special glue must be employed to fasten the hook-and-loop tape in the gullet channel of the saddle.

The use of such hook-and-loop tapes with the requisite gluing operation is complicated and for this reason not well accepted among riders.

It is therefore a goal of the invention to devise a saddle pad for a riding animal in a manner as well suited to the anatomy as possible, it being possible to dispense with hook-and-loop tapes or adhesives.

With the features provided in Claim 1, the invention achieves this goal in that a recess in the shape of a lengthwise groove is made in the saddlecloth in the region lying over the spine of the riding animal, so that the panels lying on the flanks of the riding animal have a greater thickness than the web lying over the spine and connecting the two panels to one another.

As a result of the measure according to the invention of providing a groove-like recess along the central longitudinal axis of the saddlecloth, that is, along the spine of the riding animal, the saddlecloth rests only on the flanks of the riding animal, so that a cavity is formed over the spine. For this reason, no pressure is exerted on the spine from above. Instead, the weight of the rider is distributed in large-area fashion via the panels of the saddlecloth onto the flanks of the riding animal.

An exemplary embodiment of the saddlecloth according to the invention provides a thickened bulge, preferably made of a lambskin covering, at the front and/or rear end, which bulge serves primarily to guard against slipping.

A further exemplary embodiment provides a device for the fastening of a cloth, for example a slit through which a strap is passed, at the front and/or rear of the saddlecloth on the right and left panels.

The saddle pad according to the invention is preferably fabricated from lambskin, to the skin side of which is sewed a textile fabric, preferably quilted in order to make the padding higher. The saddle pad rests with the fleece side on the riding animal. A stiff quilted material can also be employed as textile fabric.

The invention is described and explained in greater detail with reference to the drawings, in which:

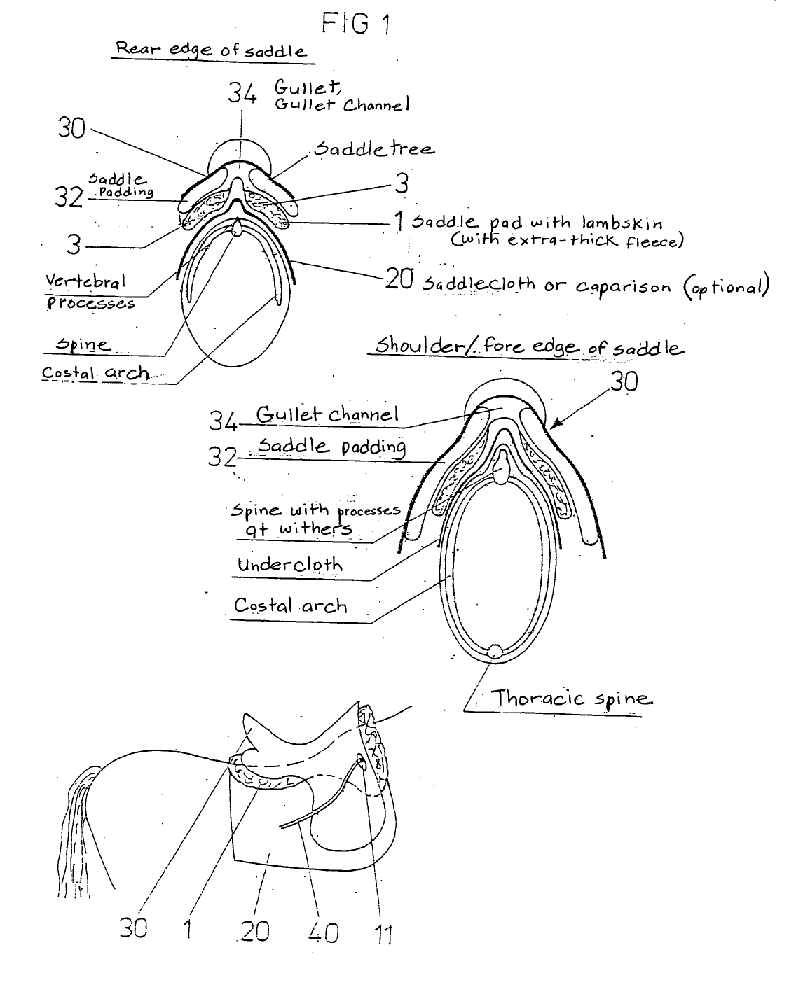

FIG. 1 shows sectional views of a horse in the region of the rear edge of the saddle as well as the front edge of the saddle, as well as a lateral view of a horse with the saddle pad according to the invention set in place and with saddle set thereon;

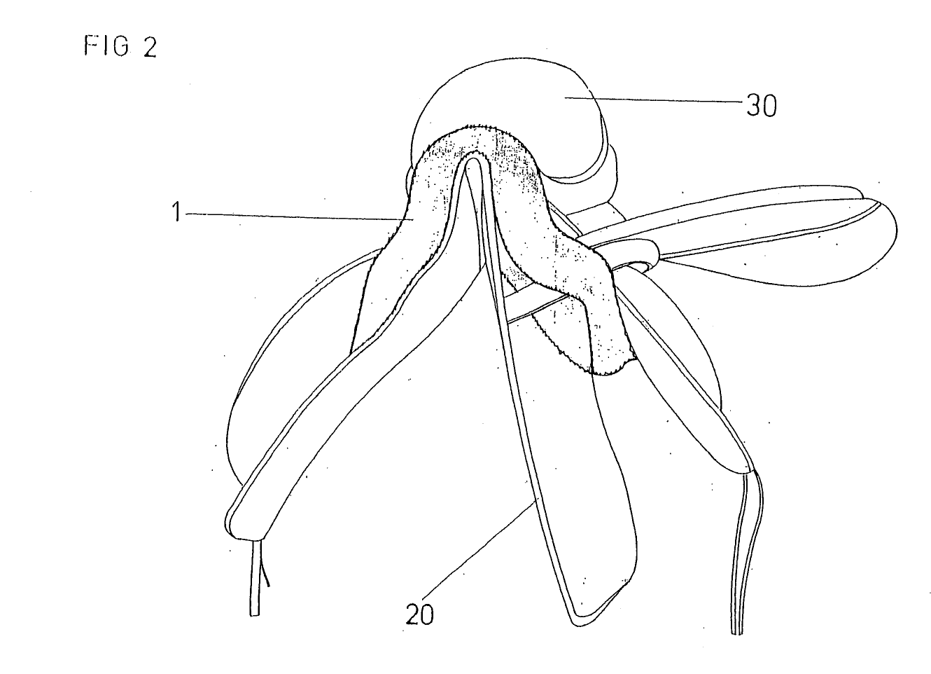

FIG. 2 is a perspective view of the saddle pad with saddle from obliquely forward;

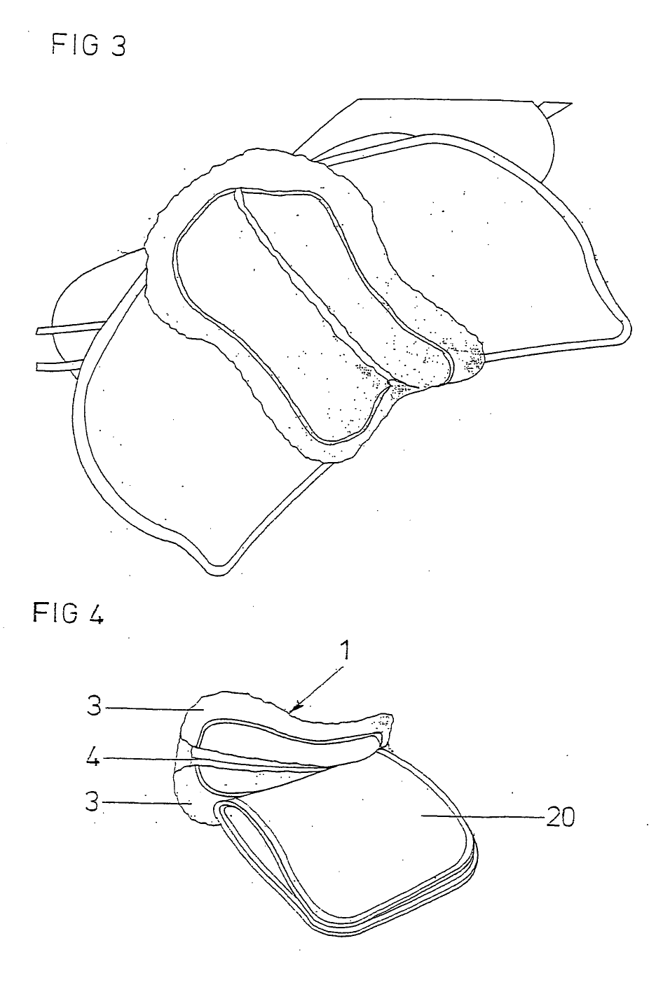

FIG. 3 is a perspective view from obliquely below; and

FIG. 4 is a perspective view from obliquely below with saddle pad as well as saddlecloth.

FIG. 1, at top and center, shows in each case a cross section through a horse with saddle pad according to the invention set in place. The respective technical names are entered in FIG. 1. At the bottom in FIG. 1, the horse is depicted in partial lateral view.

Saddle pad 1 rests on back 2 above the costal arch of the horse. A so-called saddle cloth or caparison 20 can lie between saddle pad 1 and horse. A saddle 30 rests on saddle pad 1. Saddle 30 has saddle padding 32. Running centrally on the underside of saddle 30 is a gullet or so-called gullet channel 34.

Saddle pad 1 comprises two panels 3, which are connected to one another by a web 4 that lies over the spine 5 of the riding animal. In web 4 there is made a recess 4 in the shape of a longitudinal groove, which has no lambskin covering but only the textile fabric and is thereby fashioned markedly thinner than the remaining region of saddle pad 1. This region not covered with lambskin can be discerned quite clearly in FIG. 4. The two panels 3 of saddlecloth 1 each comprise a lambskin 7 on the upper surface of which there is sewed a textile fabric 8, which is preferably quilted in order to make the padding higher. Saddlecloth 1 rests with the fleece side of lambskin 7 on trunk 9 of the riding animal. At the front and/or rear end of web 4 there is a bulge 10, which fixes saddle pad 1 under the saddle in the gullet channel of the saddle and serves in particular to guard against slipping.

As a result of the fashioning of saddle pad 1 as described above, the saddle pad is automatically pressed with its web into the gullet channel of the saddle and makes certain at the same time that there is an adequate ventilation channel above the spine of the horse between the horse and the saddle pad.

In a development of the invention, the saddle pad can be combined in a simple way with a saddlecloth 20 to be laid under saddle pad 1. For this purpose, saddle pad 1 and saddlecloth 20 have suitable fastening devices. Thus for example there can be a slit 11 at the front and/or rear of each panel 3, through which slit straps 22 attached to saddlecloth 20 can be passed. Saddlecloth 20 is fabricated for example from textile fabric. In order to enhance the cushioning effect, this textile cloth can also be quilted.

The saddle pad 1 according to the invention is especially well-suited to saddle horses.

Lambskin is particularly suitable as the lower covering for saddle pad 1 because the thickness of the upright-standing fibers is sufficiently high and the fibers of the lambskin slide into one another so that friction against the horse's back is largely prevented, even when the saddle moves or the horse moves beneath the saddle. Pressure alone without friction does not cause injury to the horse's skin. Similar results can also be attained with high-quality wool nonwovens, provided the density of the fibers is not brought about by crimping of the fibers.

1. Saddle pad (1) for laying on the back (2) of a riding animal, characterized in that a recess (6) in the shape of a lengthwise groove is made in the saddle pad (1) in the region lying over the spine (5) of the riding animal, so that the panels (3) resting on the flanks of the riding animal have a greater thickness than the web (4) connecting the two panels (3) to one another over the spine.

2. Saddle pad according to claim 1, characterized in that there is a bulge (10) at the front and/or rear end of the web (4).

3. Saddle pad according to claim 1 or 2, characterized in that at the front and/or rear end of each panel (3) there is in each case a device (11) for fastening a saddlecloth (20).

4. Saddle pad according to claim 3, characterized in that at the front and/or rear end of each panel (3) there is in each case a slit (11) through which a strap (40) is passed.

5. Saddle pad according to claim 4, characterized in that a saddlecloth (20) is fastenable under the saddle pad by straps (40) that can be passed through the slits (11) of the panels (3).

6. Saddle pad according to one of the foregoing claims, characterized in that the panels (3) of the saddlecloth (1) are made of lambskin, to the skin side of which a textile fabric is sewed.

7. Saddle pad according to claim 6, characterized in that the web (4) consists of the textile fabric (8).

8. Saddle pad according to claim 6 or 7, characterized in that the textile fabric (8) is quilted.

9. Saddle pad according to one of claims 1 to 8, characterized in that the saddle pad (1) is covered with lambskin in the region of the undersides of its panels (3).
